(19) United States
(12) Patent Application Publication
(10) Pub. No.: US 2013/0106888 A1
(43) Pub. Date: May 2, 2013

(54) INTERACTIVELY ZOOMING CONTENT DURING A PRESENTATION

(71) Applicants: Nathan Robert Penner, Mountain View, CA (US); Ryan Charles Hill, Mountain View, CA (US)

(72) Inventors: Nathan Robert Penner, Mountain View, CA (US); Ryan Charles Hill, Mountain View, CA (US)

(73) Assignee: MICROSOFT CORPORATION, Redmond, WA (US)

(21) Appl. No.: 13/287,740

(22) Filed: Nov. 2, 2011

(51) Int. Cl. G09G 5/00; G09G 5/02

(52) U.S. Cl. 345/582; 345/660; 345/589

(57) ABSTRACT

While delivering a presentation, content within the presentation may be zoomed and/or panned. Presenters may freely zoom content during their presentation, including during the times when animations, transitions, and/or multimedia is playing. The zoomed content may also be interacted with (e.g. selecting hyperlinks, adding annotations). The content to zoom may be an object within the slide (e.g. table, chart, picture, . . . ) and/or a selection of a portion of the slide. The zoomed content may appear in a different portion of the display after zooming (e.g. content that is zoomed may be centered within the display). The content to zoom may be set on a secondary display before zooming the content presented to the audience. A different rendering method may be used to present the zoomed content. A spotlight animation effect may be used to zoom specific objects to fill the front and center of the display during presentation.

### BACKGROUND

Many presenters display slides during a presentation. Some audience members may not be able to see all of the content on one or more of the slides. For example, slides may display small content and/or dense information that can be difficult to view from the back of a room during a presentation. The presentation may also be difficult to view on a limited display device (e.g. tablet, mobile phone, laptop, and the like).

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

While delivering a presentation, content within the presentation may be zoomed and/or panned. Presenters may freely zoom content during their presentation, including during the times when animations, transitions, and/or multimedia is playing. The zoomed content may also be interacted with (e.g. selecting hyperlinks, adding annotations). The content to zoom may be an object within the slide (e.g. table, chart, picture, . . . ) and/or a selection of a portion of the slide. The zoomed content may appear in a different portion of the display after zooming (e.g. content that is zoomed may be centered within the display). Zoomable content may be shown differently from content that is not zoomable such that a user may readily determine what content may be zoomed. The content to zoom may be set on a secondary display before zooming the content presented to the audience. A different rendering method may be used to present the zoomed content. A spotlight animation effect may be used to zoom specific objects to fill the front and center of the display during presentation.

### BRIEF DESCRIPTION OF THE DRAWINGS

FIG. 1 illustrates an exemplary computing device;

FIG. 2 illustrates an exemplary system for providing zoom effects during a presentation;

FIG. 3 shows a process for interactive zooming of content during a presentation.

FIG. 4 illustrates a process for identifying content and adjusting a display of the zoomed content on a presenter display before showing the zoomed content on an audience display;

FIG. 5 shows a process for zooming content within a presentation;

FIG. 6 illustrates a system architecture for interactively zooming content during a presentation;

FIGS. 7-18 show exemplary zoom displays.

### DETAILED DESCRIPTION

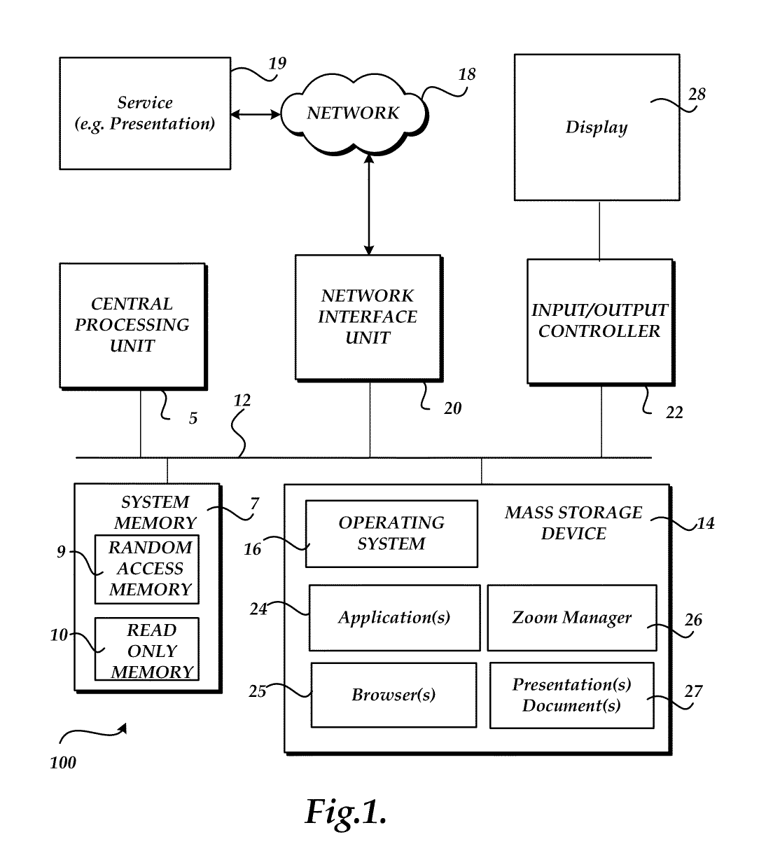

Referring now to the drawings, in which like numerals represent like elements, various embodiments will be described. In particular, FIG. 1 and the corresponding discussion are intended to provide a brief, general description of a suitable computing environment in which embodiments may be implemented.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Referring now to FIG. 1, an illustrative computer architecture for a computer 100 utilized in the various embodiments will be described. The computer architecture shown in FIG. 1 may be configured as a server computing device, a desktop computing device, a mobile computing device (e.g. smartphone, notebook, tablet . . . ) and includes a central processing unit 5 (“CPU”), a system memory 7, including a random access memory 9 (“RAM”) and a read-only memory (“ROM”) 10, and a system bus 12 that couples the memory to the central processing unit (“CPU”) 5.

A basic input/output system containing the basic routines that help to transfer information between elements within the computer, such as during startup, is stored in the ROM 10. The computer 100 further includes a mass storage device 14 for storing an operating system 16, application(s) 24, presentation(s)/document(s) 27, and other program modules, such as Web browser 25, and zoom manager 26, which will be described in greater detail below.

The mass storage device 14 is connected to the CPU 5 through a mass storage controller (not shown) connected to the bus 12. The mass storage device 14 and its associated computer-readable media provide non-volatile storage for the computer 100. Although the description of computer-readable media contained herein refers to a mass storage device, such as a hard disk or CD-ROM drive, the computer-readable media can be any available media that can be accessed by the computer 100.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, Erasable Programmable Read Only Memory (“EPROM”), Electrically Erasable Programmable Read Only Memory (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 100.

According to various embodiments, computer 100 may operate in a networked environment using logical connections to remote computers through a network 18, such as the Internet. The computer 100 may connect to the network 18 through a network interface unit 20 connected to the bus 12. The network connection may be wireless and/or wired. The network interface unit 20 may also be utilized to connect to other types of networks and remote computer systems. The computer 100 may also include an input/output controller 22 for receiving and processing input from a number of other devices, such as a touch input device. The touch input device may utilize any technology that allows single/multi-touch input to be recognized (touching/non-touching). For example, the technologies may include, but are not limited to: heat, finger pressure, high capture rate cameras, infrared light, optic capture, tuned electromagnetic induction, ultrasonic receivers, transducer microphones, laser rangefinders, shadow capture, and the like. According to an embodiment, the touch input device may be configured to detect near-touches (i.e. within some distance of the touch input device but not physically touching the touch input device). The touch input device may also act as a display 28. The input/output controller 22 may also provide output to one or more display screens, a printer, or other type of output device.

A camera and/or some other sensing device may be operative to record one or more users and capture motions and/or gestures made by users of a computing device. Sensing device may be further operative to capture spoken words, such as by a microphone and/or capture other inputs from a user such as by a keyboard and/or mouse (not pictured). The sensing device may comprise any motion detection device capable of detecting the movement of a user. For example, a camera may comprise a MICROSOFT KINECT® motion capture device comprising a plurality of cameras and a plurality of microphones.

Embodiments of the invention may be practiced via a system-on-a-chip (SOC) where each or many of the components/processes illustrated in the FIGURES may be integrated onto a single integrated circuit. Such a SOC device may include one or more processing units, graphics units, communications units, system virtualization units and various application functionality all of which are integrated (or “burned”) onto the chip substrate as a single integrated circuit. When operating via a SOC, all/some of the functionality, described herein, may be integrated with other components of the computer 100 on the single integrated circuit (chip).

As mentioned briefly above, a number of program modules and data files may be stored in the mass storage device 14 and RAM 9 of the computer 100, including an operating system 16 suitable for controlling the operation of a networked computer, such as the WINDOWS SERVER®, WINDOWS 7® operating systems from MICROSOFT CORPORATION of Redmond, Wash.

The mass storage device 14 and RAM 9 may also store one or more program modules. In particular, the mass storage device 14 and the RAM 9 may store one or more applications, such as a zoom manager 26, productivity applications 24 (e.g. a presentation application such MICROSOFT POWERPOINT), and may store one or more Web browsers 25. The Web browser 25 is operative to request, receive, render, and provide interactivity with electronic content, such as Web pages, videos, documents, and the like. According to an embodiment, the Web browser comprises the INTERNET EXPLORER Web browser application program from MICROSOFT CORPORATION.

Zoom manager 26 may be on a client device and/or on a server device (e.g. within service 19). Zoom manager 26 may be configured as an application/process and/or as part of a cloud based multi-tenant service that provides resources (e.g. services, data . . . ) to different tenants (e.g. MICROSOFT OFFICE 365, MICROSOFT WEB APPS, MICROSOFT SHAREPOINT ONLINE).

Generally, zoom manager 26 is configured to interactively show zoom effects during a presentation of slides. While delivering a presentation, content within the presentation may be zoomed and/or panned. Presenters may freely zoom content during their presentation, including during the times when animations, transitions, and/or multimedia is playing. The zoomed content may also be interacted with (e.g. selecting hyperlinks, adding annotations). The content to zoom may be an object within the slide (e.g. table, chart, picture, . . . ) and/or a selection of a portion of the slide. The zoomed content may appear in a different portion of the display after zooming (e.g. content that is zoomed may be centered within the display). Zoomable content may be shown differently from content that is not zoomable such that a user may readily determine what content may be zoomed. The content to zoom may be set on a secondary display before zooming the content presented to the audience. A different rendering method may be used to present the zoomed content. A spotlight animation effect may be used to zoom specific objects to fill the front and center of the display during presentation. Additional details regarding the operation of zoom manager 26 will be provided below.

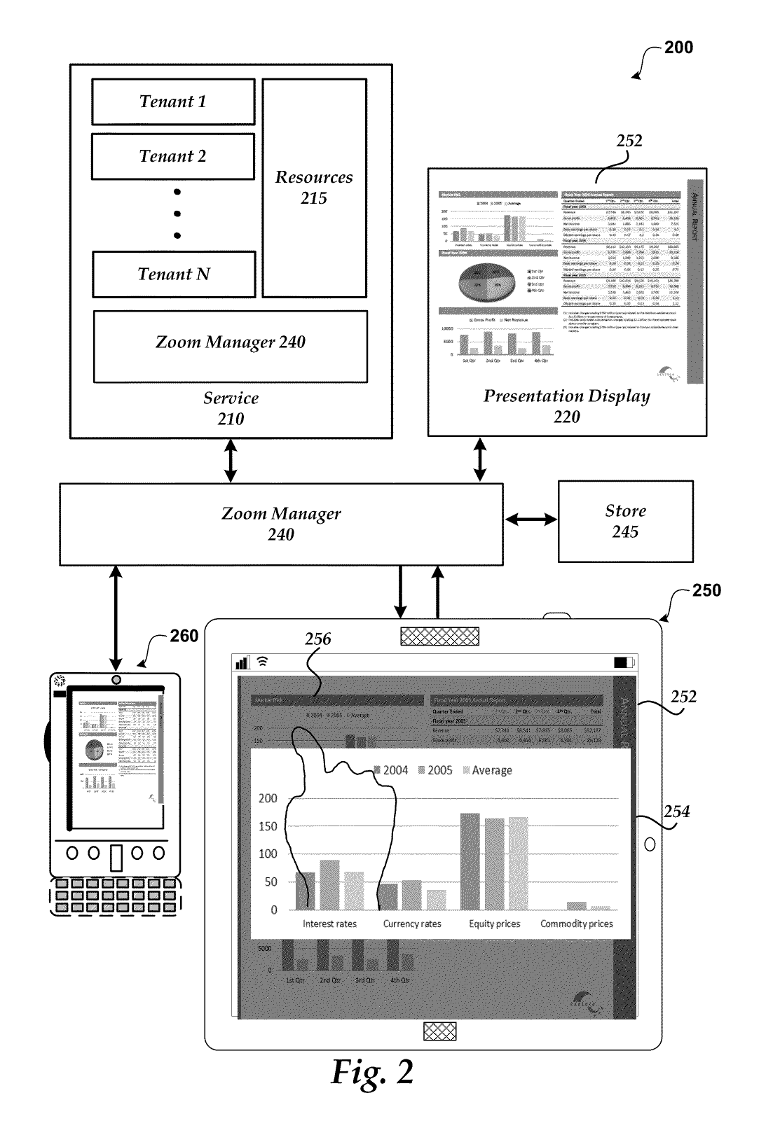

FIG. 2 illustrates an exemplary system for providing zoom effects during a presentation. As illustrated, system 200 includes service 210, zoom manager 240, store 245 and touch screen input device/display 250 (e.g. slate) and smart phone 260.

As illustrated, service 210 is a cloud based and/or enterprise based service that may be configured to provide presentation services (e.g. MICROSOFT OFFICE 365, MICROSOFT WEB APPS, MICROSOFT POWERPOINT). Functionality of one or more of the services/applications provided by service 210 may also be configured as a client based application. For example, a client device may include a presentation application used to display slides and the service 210 may provide the functionality of the presentation application. Although system 200 shows a presentation service, other services/applications may be configured to provide zoom effects during a presentation.

As illustrated, service 210 is a multi-tenant service that provides resources 215 and services to any number of tenants (e.g. Tenants 1-N). According to an embodiment, multi-tenant service 210 is a cloud based service that provides resources/services 215 to tenants subscribed to the service and maintains each tenant's data separately and protected from other tenant data.

System 200 as illustrated comprises a touch screen input device/display 250 (e.g. a slate/tablet device) and mobile phone 260 that detects when a touch input has been received (e.g. a finger touching or nearly touching the touch screen). Any type of touch screen may be utilized that detects a user's touch input. For example, the touch screen may include one or more layers of capacitive material that detects the touch input. Other sensors may be used in addition to or in place of the capacitive material. For example, Infrared (IR) sensors may be used. According to an embodiment, the touch screen is configured to detect objects that in contact with or above a touchable surface. Although the term “above” is used in this description, it should be understood that the orientation of the touch panel system is irrelevant. The term “above” is intended to be applicable to all such orientations. The touch screen may be configured to determine locations of where touch input is received (e.g. a starting point, intermediate points and an ending point). Actual contact between the touchable surface and the object may be detected by any suitable means, including, for example, by a vibration sensor or microphone coupled to the touch panel. A non-exhaustive list of examples for sensors to detect contact includes pressure-based mechanisms, micro-machined accelerometers, piezoelectric devices, capacitive sensors, resistive sensors, inductive sensors, laser vibrometers, and LED vibrometers.

As illustrated, touch screen input device/display 250 shows an exemplary slide 252 that is part of a presentation. Zoom manager 240 is configured to receive input from a user (e.g. using touch-sensitive input device 250 and/or keyboard input (e.g. a physical keyboard and/or SIP)). For example, zoom manager 240 may receive touch input that is associated with a presentation 252.

In the current example, a user has selected chart 256 that is shown in slide 252 of the presentation to zoom. In response to the selection, chart 256 is zoomed and displayed in a zoomed state 254. The zoomed content may be displayed differently depending on the configuration. In the current example, a spotlight effect is displayed when the content is zoomed that animates the zooming of chart 256 and dims the background (e.g. chart 256 appears to grow until it is centered, and slide 252 dims in the background). When a user exits the zoom mode, an animation is performed that returns the chart to the normal un-zoomed state. A user may enter the zoom state at any point during a presentation using touch input, a mouse, keyboard, and the like.

The user can show the full-screen presentation (e.g. audience view) on one display (e.g. presentation display 220) and a private “presenter view” on a second display (e.g. device 250). The presentation may be displayed on a variety of different devices (e.g. slates, mobile phones, laptops, desktop computers, kiosks, . . . ). The presenter view includes a preview of the current slide 252 being seen by the audience. The presenter can select and preview a zoom area on the presenter display without the audience seeing it. The selection may be made using different methods. For example, a presenter may select an area of the slide that they would like to zoom into and/or select a zoomable object within the displayed slide. The presenter may manipulate the preview of the zoomed content (e.g. change a selection, pan, etc.) before the zoomed content is displayed on the presentation display. While the user is previewing the zoomed content and making any adjustments, the audience sees no change. When the presenter chooses the final content to zoom (e.g. selecting a UI element, removing their finger(s) from the display, releasing a mouse button), the audience may then see a smooth animation from the present state of the slide to the new zoom state as determined by the presenter. This helps to enable the presenter to show a polished and precise zoom effect. For example, the mouse may wobble while the user pans on the presenter view, but the audience display will move in a straight line to the new position. The audience display may also be configured to update as the presenter display is updated. Many more examples and details are provided in the FIGURES and description below.

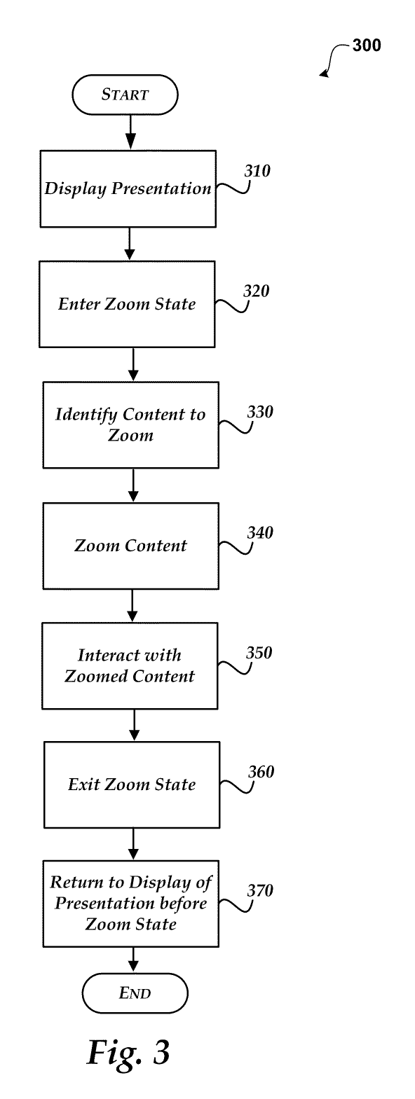

FIGS. 3-5 show an illustrative process for interactive zooming of content during a presentation. When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof.

FIG. 3 shows a process for interactive zooming of content during a presentation.

After a start operation, the process flows to operation 310 where a presentation is accessed and displayed. For example, the presentation may include a display of presentation slides that are shown in a particular order. The slides may contain a variety of content (e.g. text, pictures, chart, tables, graphs, videos, animations, and the like.)

Moving to operation 320, a zoom state is entered. The zoom state may be entered at any point during a presentation display of the slides. The zoom state may be entered using touch input and/or other input (e.g. mouse, stylus, . . . ). According to an embodiment, for non-touch input a zoom graphical user interface (GUI) element is selected. A context menu may be displayed to enter the zoom mode, a menu option within a ribbon GUI, and the like, may be used to enter the zoom state. Touch gestures may be used to identify content to zoom and to adjust a zoom of content. For example, a pinch apart gesture may zoom in on the content smoothly with the user's fingers (e.g. between 100% and 200%). A pinch together gesture may zoom out the content smoothly with the user's fingers (e.g. between 100% and 200%). A pinching together gesture snaps the content to a 100% view). A pinch and drag gesture may zoom and pan the content). Other touch gestures may be configured to enter/exit the zoom state and interact with the content. According to an embodiment, shortcuts (e.g. keyboard shortcuts) may be used to enter/exit/change settings that are associated with the zoom state.

Flowing to operation 330, the content to zoom is identified. For example, a user may select a portion of the content to zoom (e.g. using a bounding box that may be moved and resized to adjust the selected content. An object displayed within the presentation may be selected (e.g. a table, chart, graph, video, animation, spreadsheet, . . . ). According to an embodiment, non-zoomable content is displayed differently from content that may be zoomed. For example, the zoomable content may be shown brighter than non-zoomable content, a border may be placed around the zoomable content, or some other indicator may be shown to indicate the zoomable content.

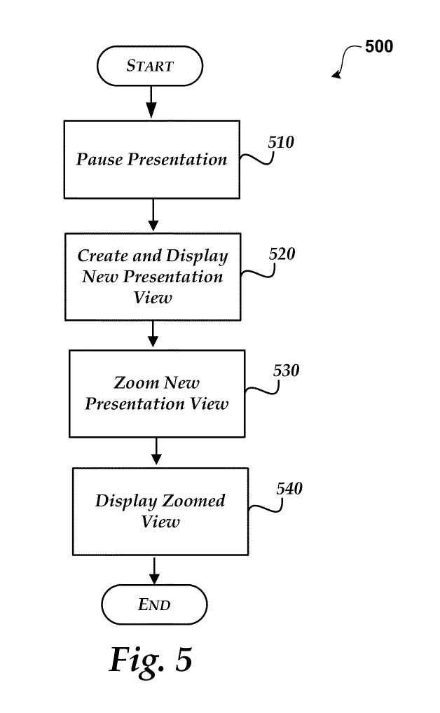

Transitioning to operation 340, the identified content is zoomed. The scale which to zoom the identified content may be configured (e.g. 125%, 150%, 175%, 200% . . . ). According to an embodiment, the zoom factor is set to 200%. According to an embodiment, a zoom multiplier is applied to each successive zoom level. For example, a zoom multiplier of 1.26 results in a zoom at 100%, 126%, 158%, 200%, and the like. Using the zoom multiplier, the zoom may appear like the same amount of zoom is applied at each successive level. Different zoom multipliers and a number of zoom levels may be configured. The zoomed content may be displayed in different manners. For example, the zoomed content may be configured to display over the slide, the zoomed content may be centered and highlighted, and the like. One or more animations may also be played between the initial zoom state of the content and the final zoom state of the content (See FIGURES herein for exemplary displays showing different zoom methods). See FIG. 5 and related discussion for more details on zooming the identified content.

During the zoomed state, playback of animations, transitions, video, and other visual effects continue to be occur. According to an embodiment, the playback of animations, transitions, video, and other visual effects may be temporarily paused while in the zoom state.

Moving to operation 350, a user may interact with the zoomed content. For example, a user may change a zoom level, pan (left, right, up, down) the zoomed content, identify another object/content to zoom, and the like. Presenters may continue to interact with selectable content that is zoomed (e.g. hyperlinks, triggered animations, and the like) while in the zoom state. Presenters may also annotate the slide with ink, a laser pointer, or highlighter tool while in the zoom state. Some content may be zoomed differently. For example, video content may be zoomed such that it plays full screen of the display.

Flowing to operation 360, the zoom state is exited in response to a user action (e.g. touch gesture, selection of a GUI element, . . . ).

Transitioning to operation 370, the display of the presentation returns to its previously displayed state (e.g. 100%).

The process then moves to an end operation and returns to processing other actions.

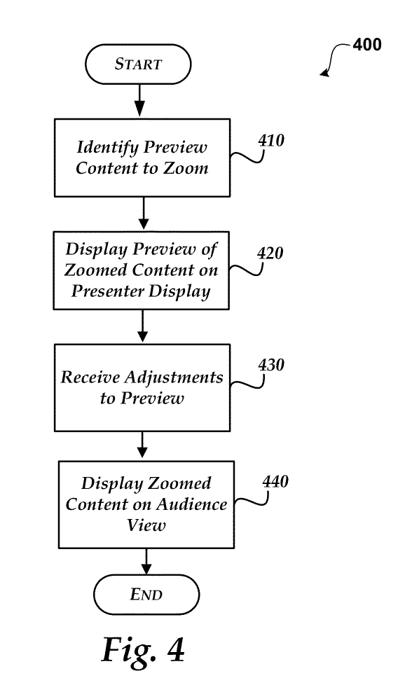

FIG. 4 illustrates a process for identifying content and adjusting a display of the zoomed content on a presenter display before showing the zoomed content on an audience display.

After a start operation, the process 400 flows to operation 410, where an preview content to zoom is identified. The selection may be made using different methods. For example, a presenter may select an area of the slide that they would like to zoom into and/or select a zoomable object within the displayed slide.

Moving to operation 420, the preview of zoomed content is displayed on a presenter display that viewed by the presenter without updating an audience display (e.g. projector) that is used to display the presentation to the audience. The presenter view includes a preview of a slide before is seen by the audience and/or during a time it is seen by the audience.

Flowing to operation 430, the presenter may adjust the display of the zoomed content. The presenter may manipulate the preview of the zoomed content (e.g. change a selection, pan, etc.) on the presenter display before the zoomed content is displayed on the audience display. While the user is previewing the zoomed content and making any adjustments, the audience does not see changes being made by the presenter.

Transitioning to operation 440, the zoomed content as determined and viewed by the presenter is displayed to the audience on the audience display.

The process then moves to an end operation and returns to processing other actions.

FIG. 5 shows a process for zooming content within a presentation.

After a start operation, the process flows to operation 510 where the presentation is temporarily paused.

Moving to operation 520, a new presentation view is created and displayed. According to an embodiment, for a default presentation view (e.g. at 100%) the slides within the presentation are rendered directly to the screen using sprites. When the user enters the zoom state and the slide show is temporarily paused, a new view is created that is separate from the slide show view. This new view initially displays a static texture of the full slide at 100%. In this way, the users do not notice a visual change to the presentation. Other zooming methods may be used. For example, during a slide presentation some objects are rendered in a resolution-independent vector format so that re-rendering is not required when the zoom scale, and the object's resolution, changes. For example, a solid rectangular shape would be rendered in a resolution-independent vector format, and pictures would render by scaling their native resolution original image to the needed size. Other content on the slide, e.g. 3D shapes, would continue to render at specific resolutions and would re-render whenever the zoom scale changes. This reduces the amount of re-rendering necessary when the user changes the zoom scale.

Transitioning to operation 530, the new presentation is zoomed. According to an embodiment, the texture of the slide is zoomed to a predetermined level (e.g. 200%, 150%, 125%, based on the display size).

Flowing to operation 540, the zoomed view using the new presentation view is displayed. Using a different rendering technology may increase the performance of the zoom effect.

The process then moves to an end operation and returns to processing other actions.

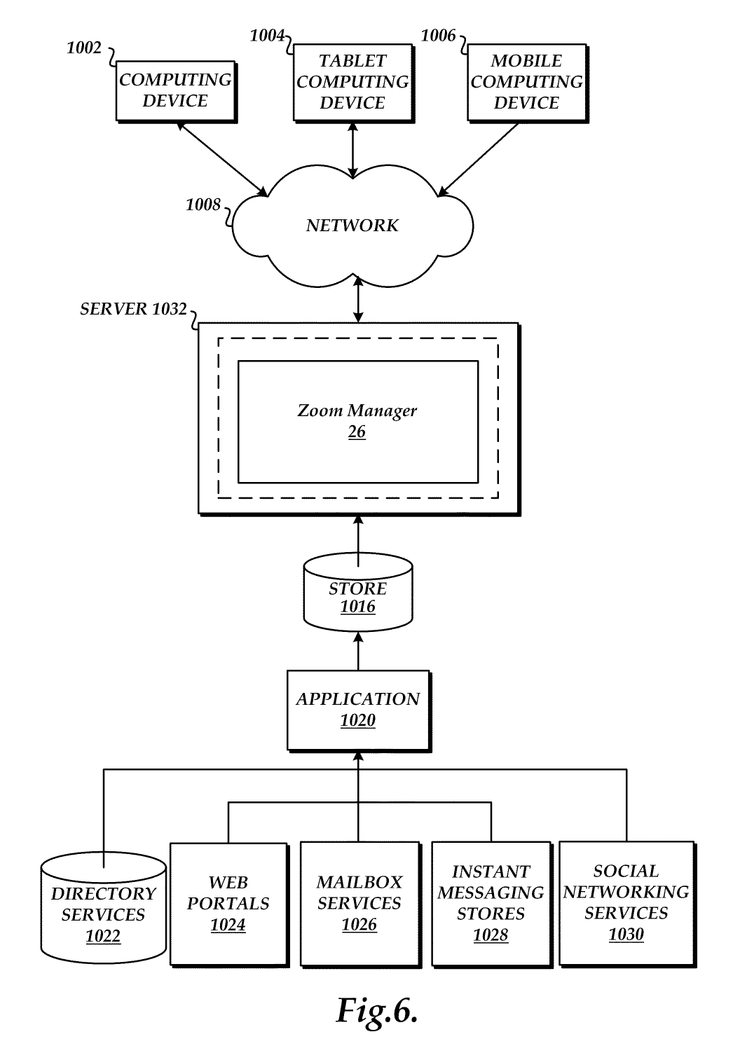

FIG. 6 illustrates a system architecture for interactively zooming content during a presentation, as described herein. Content used by the application (e.g. presentation application 1020) and the zoom manager 26 may be stored at different locations. For example, application 1020 may use/store data using directory services 1022, web portals 1024, mailbox services 1026, instant messaging stores 1028 and social networking sites 1030. The application 1052 may use any of these types of systems or the like. A server 1032 may generate zoomed content displays for application 1020 to display at a client (e.g. a browser or some other window). As one example, server 1032 may be a web server configured to provide presentation services to one or more users. Server 1032 may use the web to interact with clients through a network 1008. Server 1032 may also comprise an application program (e.g. a presentation application). Examples of clients that may interact with server 1032 and a presentation application include computing device 1002, which may include any general purpose personal computer, a tablet computing device 1004 and/or mobile computing device 1006 which may include smart phones. Any of these devices may obtain content from the store 1016.

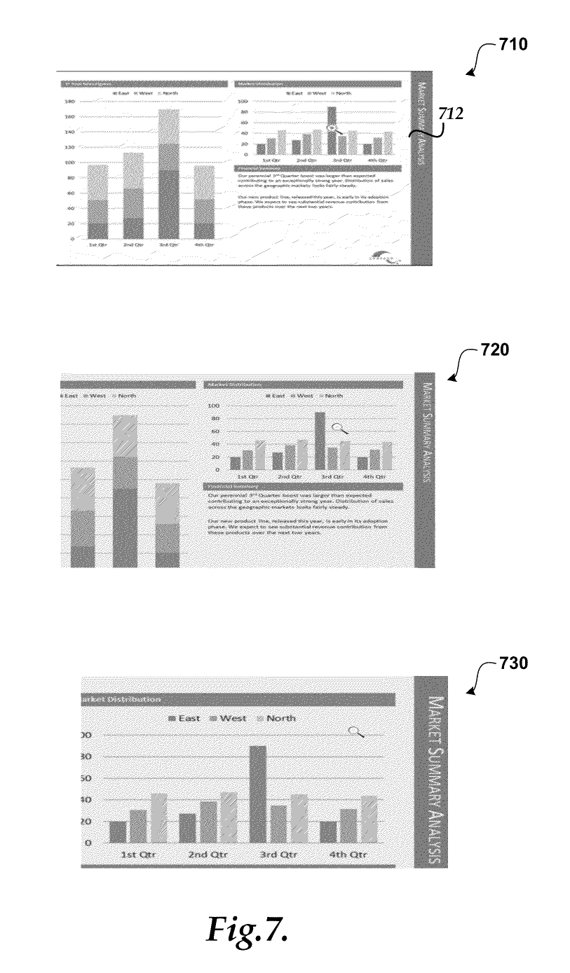

FIG. 7 shows exemplary displays showing a zoom process.

As illustrated, display 710 shows a slide before content is identified to be zoomed. In the current example, the user has selected chart 712 to zoom.

Display 720 shows a slide during the zooming of chart 712. According to an embodiment, when the user selects the content to zoom, an animation occurs that displays the content smoothly zooming to 200% (e.g. 400 ms with a smooth curve between the before zoom state and the final zoom state, centered where the user clicked or as close as possible without moving the slide partly off the screen.

Display 730 shows chart 712 after zooming. In the current example, the chart 712 covers the entire slide. While in the zoomed in state, any clicking and dragging by the user pans the slide content under the mouse/touch input. The user may also adjust the zoom scale. According to an embodiment, the zooming is set to predetermined amounts (e.g. applying a zoom multiplier). The zooming may also be by smaller/larger increments.

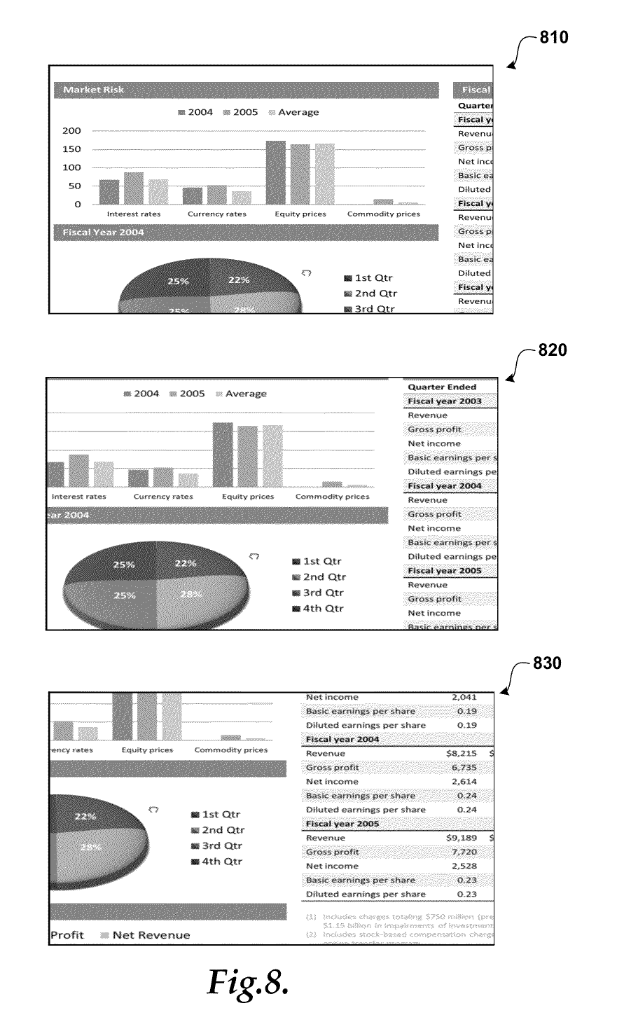

FIG. 8 shows panning while in a zoomed in state.

Display 810 shows zoomed content before panning.

Display 820 shows zoomed content while panning.

Display 830 shows zoomed content after panning.

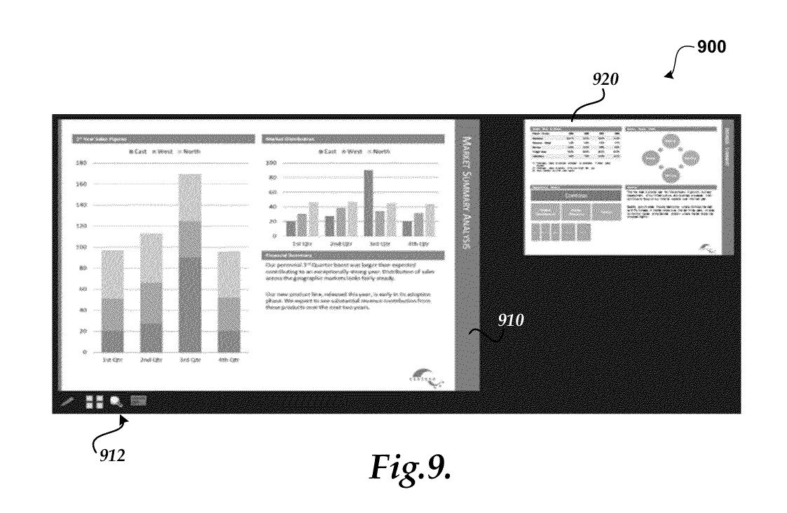

FIG. 9 shows an exemplary presenter view.

As illustrated, display 900 shows a view 910 that shows a first slide and view 920 that shows a second slide. A zoom icon 912 is displayed for entering/exiting the zoom state.

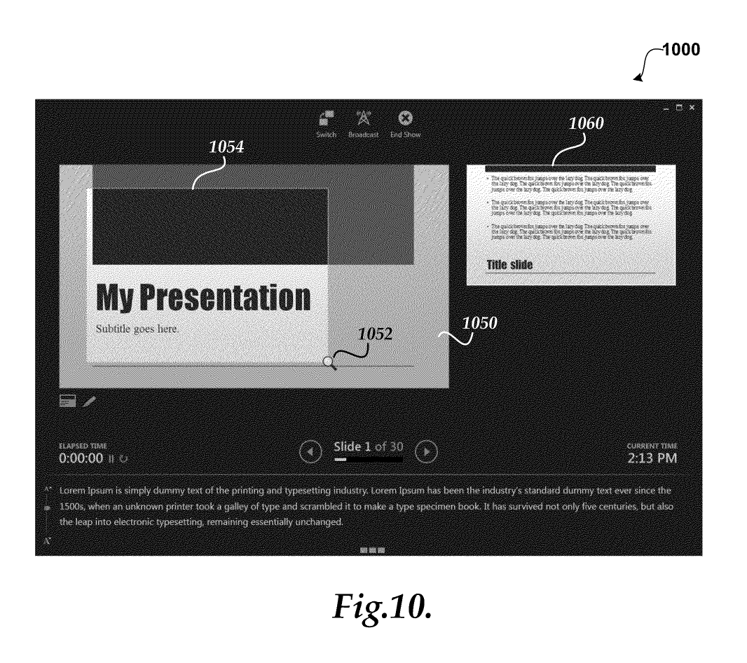

FIG. 10 shows another exemplary presenter view.

As illustrated, display 1000 shows a view 1050 that shows a first slide and view 1060 that shows a second slide. According to an embodiment, when in the zoom state, the cursor changes to a zoom cursor 1052 while hovering over the current slide preview. While the cursor is over the slide preview, a rectangle 1054 is drawn to indicate the area that is visible after zooming to a predetermined level (e.g. to 200%). The area of slide 1050 outside of rectangle 1054 is darkened. The cursor and outline are displayed on the presenter view without being displayed on the audience display.

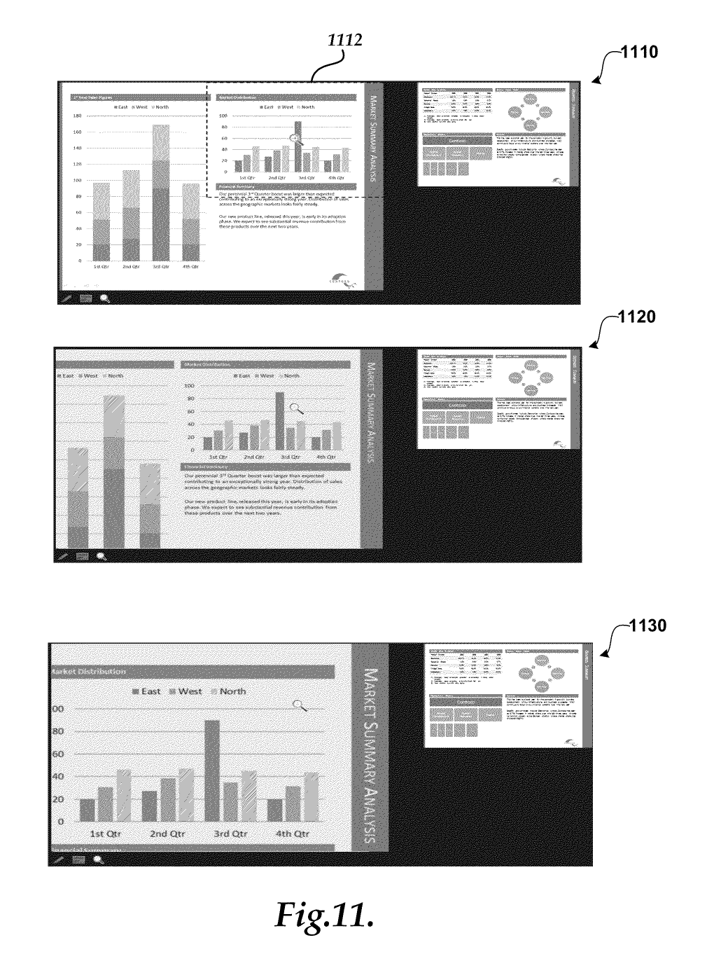

FIG. 11 shows an exemplary presenter view showing a preview of zoom.

As illustrated, display 1100 shows a bounding rectangle 1112 that indicates the portion of the content that is to be zoomed in response to selecting the content using the zoom cursor.

Display 1120 shows content while being zoomed.

Display 1130 shows the content after being zoomed.

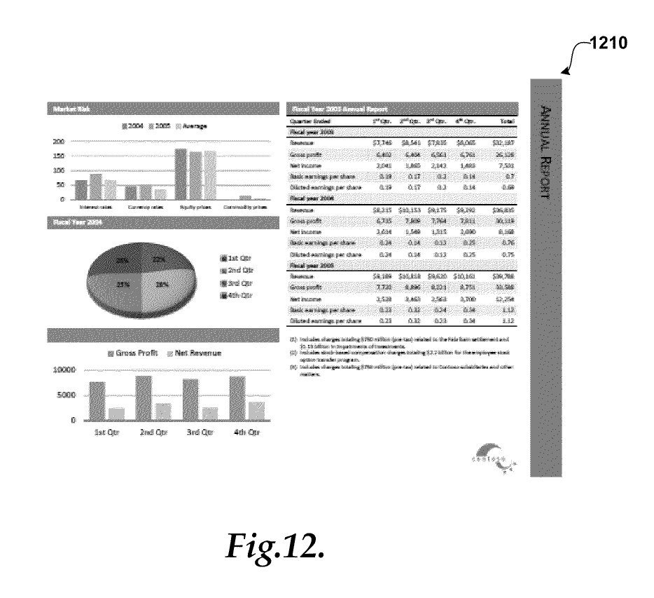

FIG. 12 shows an exemplary slide that includes different objects that may be selected for zooming.

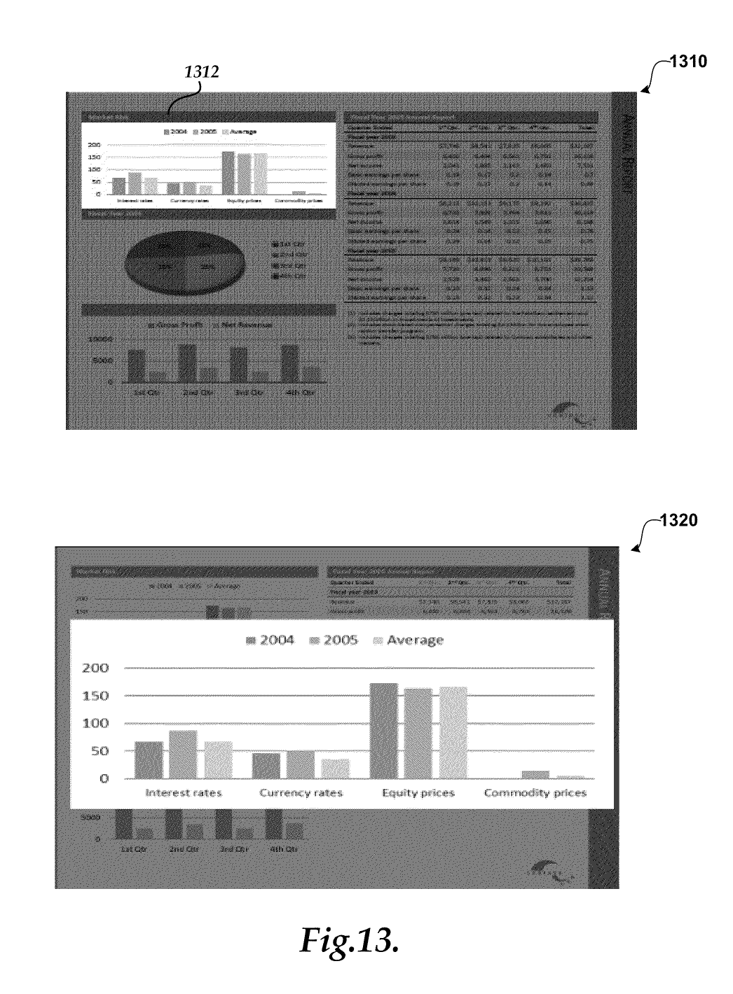

FIG. 13 shows zooming content that displays the zoomed content and non-zoomed content.

Display 1310 shows a chart 1312 being selected for zooming. The chart may be selected through a UI and/or through touch input. According to an embodiment, when the chart is selected for zooming, the unselected content is shown in a dimmed manner as compared to the original slide (See FIG. 12).

Display 1320 shows the zoomed chart after the zooming has occurred. According to an embodiment, an animation is provided during the zooming that appears to grow the content from the original size in display 1310 to the zoomed size shown in display 1320.

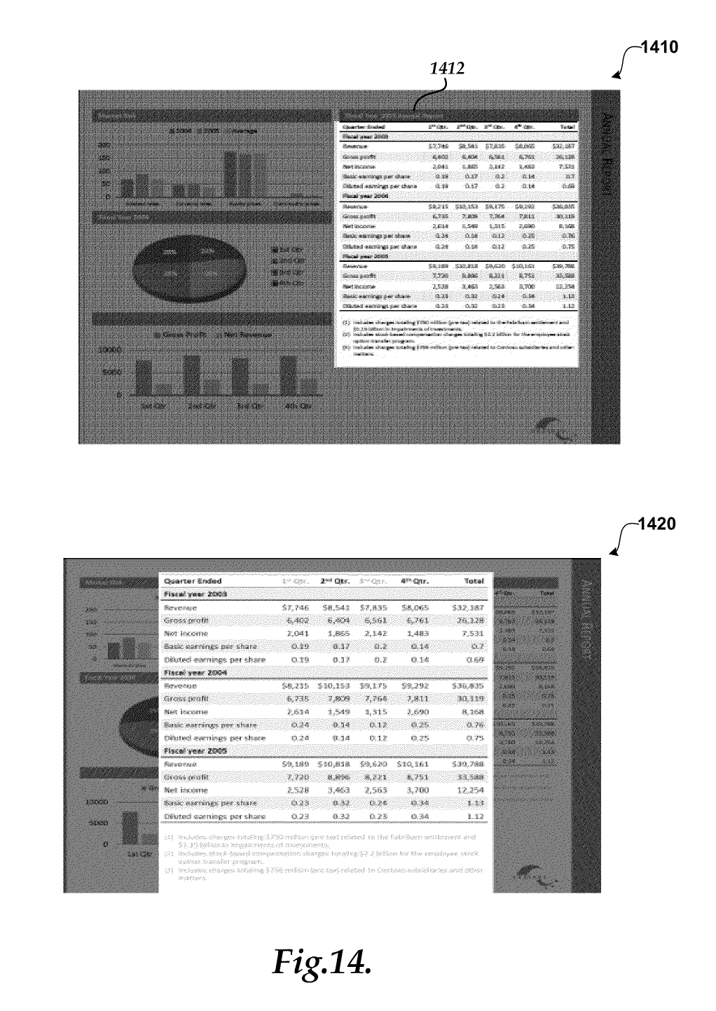

FIG. 14 shows zooming content that displays the zoomed content and non-zoomed content.

Display 1410 shows a table 1412 being selected for zooming. The table may be selected through a UI and/or through touch input. The table may also be selected for zooming from the zoomed state of another object in the slide (e.g. See FIG. 13). For example, an input may be received that cycles to a next object in the slide that can be zoomed.

Display 1420 shows the zoomed table after the zooming has occurred.

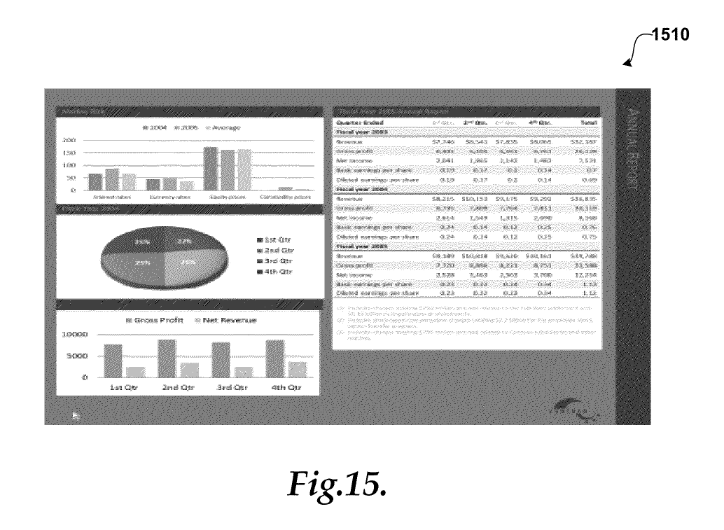

FIG. 15 shows a spotlight mode for zooming content.

Display 1510 shows a slide after the spotlight mode is entered. The spotlight mode may be entered/exited through a UI and/or through touch input. For example, an icon may be selected to enter the spotlight mode. In response to entering the spotlight mode each object within the slide that is zoomable is spotlighted. As illustrated, each object is displayed brighter than the other content on the screen. The content to zoom may be selected as described herein.

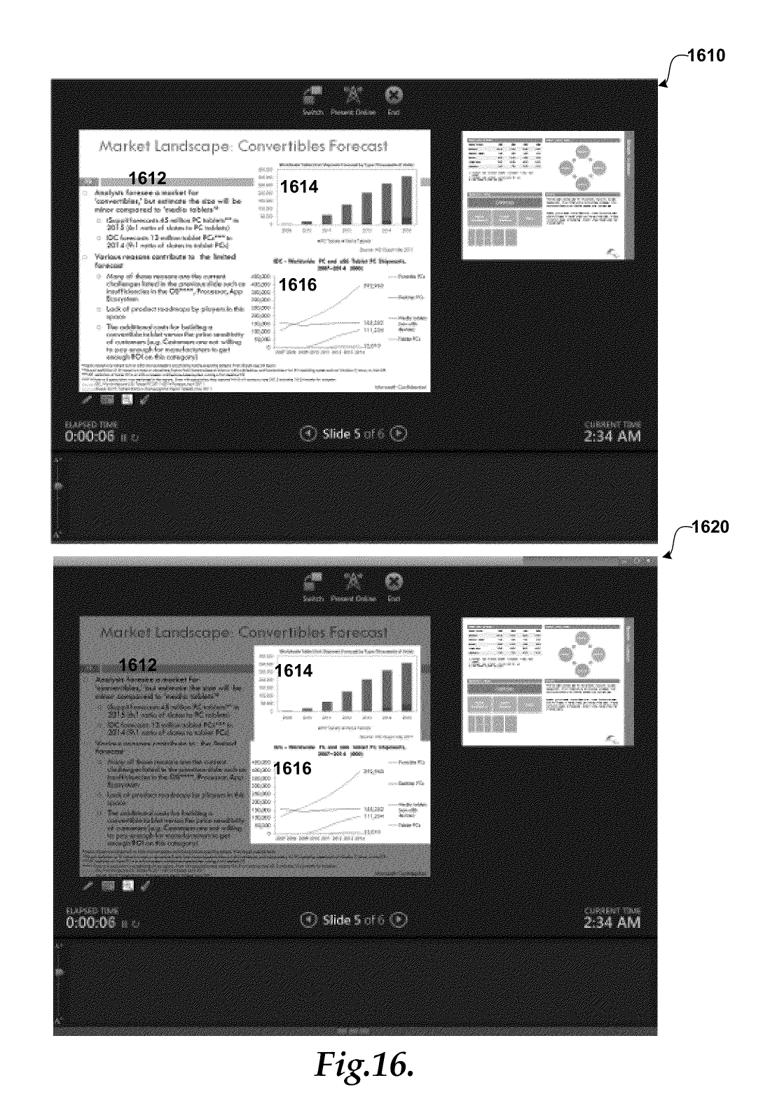

FIG. 16 shows distinguishing zoomable content from non-zoomable content within a slide.

Display 1610 shows a slide before indicating zoomable content. As illustrated, slide 1610 includes content 1612, chart 1614 and chart 1616.

Display 1620 shows a slide showing zoomable content differently from non-zoomable content. As illustrated, slide 1620 shows that content 1612 is non-zoomable (e.g. displayed darker than the zoomable content) and chart 1614 and chart 1616 that is zoomable content. The display of zoomable content may be automatically/manually displayed. For example, a user may select a UI element and/or the zoomable content may automatically be displayed when the zoom mode is entered. An animation effect may be displayed when showing the zoomable content. For example, the non-zoomable content may be dimmed at a predetermined rate until the non-zoomable content reaches the desired luminosity value.

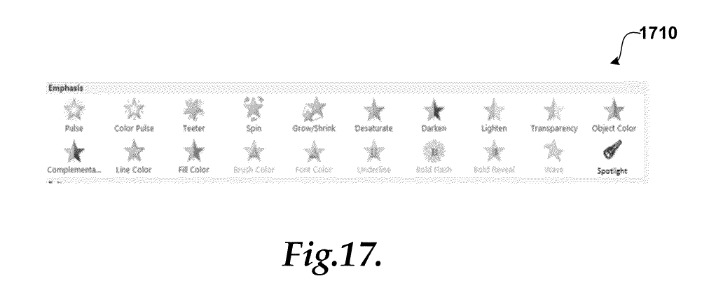

FIG. 17 shows exemplary UI elements to configure the spotlight mode.

The spotlight mode may be configured before a presentation to create the desired zoom effects during a presentation. The spotlight mode is a zoom effect that is applied to content during the presentation. A presenter may know in advance that they want to use a zoom effect when they reach the presentation of a slide. When creating the presentation, the user may select the spotlight mode to specify a zoom effect that is to be associated with the slide. According to an embodiment, the zoom effect of the spotlight mode is an animation that is associated with one or more slides of the presentation. The zoom effect is automatically triggered when the user advances the presentation to the slide(s) including a zoom effect. The zoom effect may be an animation that zooms in to content during a first period and zooms out when exiting the zoom effect. More than one animation may be associated with the display of the slide. A user may specify the order in which the animations occur. For example, a user could have a paragraph of text fly in on the first animation step of the slide, and a zoom effect (e.g. zooming in” to a chart as the second animation step.

Display 1710 shows an exemplary display that allows selection of the spotlight mode.

.

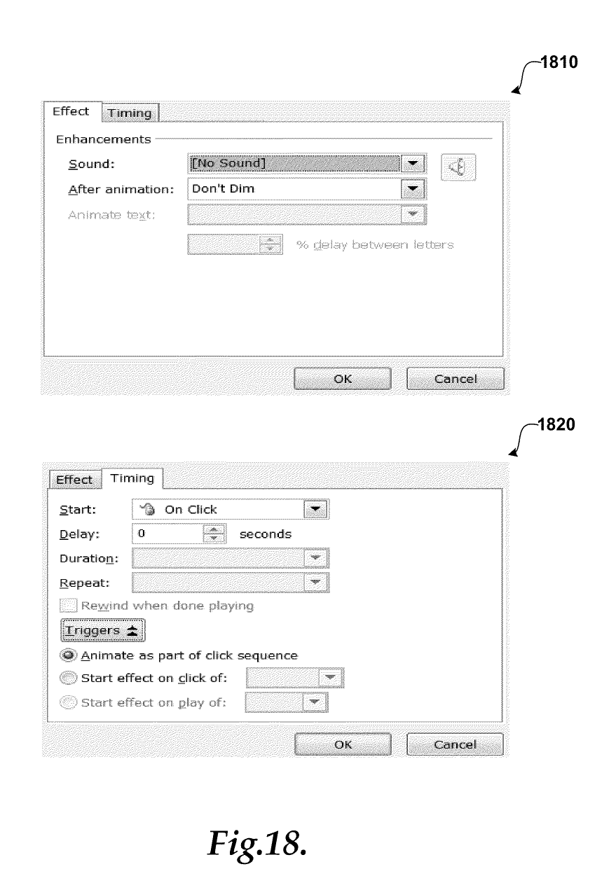

FIG. 18 shows exemplary UI elements to configure options for the spotlight mode.

Display 1810 shows an exemplary display that allows selection of spotlight mode effect options. For example, the user may add sound to the spotlight mode or change how the object appears after the zoom animation, just as with other presentation animation effects.

Display 1820 shows an exemplary display for setting timing options for the spotlight mode and also shows that the zoom effect shares the same timing option as other animations so that it can be sequenced in advance by the presenter. For example, the user may determine when the spotlight effect is to occur, a delay time, a duration time, a repeat time, different triggering options. Other options may also be configurable.

Different configurations result in different spotlight effects being applied. For example, the configurations may be set such that the object smoothly zooms to its final size and moves into a specified position, the background smoothly fades out, and the border fades in within 0.5 seconds. Other options may also be configured.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for zooming content during a presentation, comprising:
displaying content for the presentation;
identifying content to zoom during the presentation;
zooming the identified content; and
displaying the zoomed content.

2. The method of claim 1, wherein identifying the content to zoom during the presentation comprises selecting the content to zoom on a presenter display.

3. The method of claim 2, further comprising at least one of: selecting the content to zoom on a presenter display without displaying the selection of the content on an audience display and setting a zoom level on the presenter display without displaying the setting of the zoom level on the audience display.

4. The method of claim 1, further comprising displaying the zoomed content on the presenter display and when a preview and adjustment of the zoomed content is completed, displaying the zoomed content on the audience display.

5. The method of claim 1, further comprising allowing interaction with selectable items within the content while the zoomed content is displayed and allowing annotation to the zoomed content.

6. The method of claim 1, further comprising pausing the presentation upon entering a zoom mode; displaying a new presentation view that shows a texture of a current slide of the presentation; zooming the texture; and displaying the zoomed texture.

7. The method of claim 1, further comprising displaying an animation effect when the content is being zoomed.

8. The method of claim 1, further comprising displaying zoomable content within the presentation differently from non-zoomable content.

9. The method of claim 1, further comprising switching from one object that is currently zoomed to another zoomable object.

10. The method of claim 1, further comprising configuring a spotlight mode before a start of the presentation that specifies in advance of the presentation, objects within the presentation to perform a zoom effect and an order to perform the zoom effect.

11. A computer-readable medium having computer-executable instructions for zooming presentation content, comprising:
displaying content for the presentation;
identifying content to zoom during the presentation;
zooming the identified content and displaying an animation while zooming the content; and
displaying the zoomed content, wherein playback of animations, transitions, video, and other visual effects continues while the zoomed content is displayed.

12. The computer-readable medium of claim 11, wherein identifying the content to zoom during the presentation comprises selecting the content to zoom on a presenter display without displaying the selection of the content on an audience display; displaying the zoomed content on the presenter display and when a preview and adjustment of the zoomed content is completed, displaying the zoomed content on the audience display.

13. The computer-readable medium of claim 11, further comprising allowing interaction with selectable items within the content while the zoomed content is displayed and allowing annotation to the zoomed content.

14. The computer-readable medium of claim 11, further comprising pausing the presentation upon entering a zoom mode; displaying a new presentation view that shows a texture of a current slide of the presentation; zooming the texture; and displaying the zoomed texture.

15. The computer-readable medium of claim 11, further comprising displaying zoomable content within the presentation differently from non-zoomable content.

16. The computer-readable medium of claim 11, further comprising configuring a spotlight mode before a start of the presentation that defines an effect to perform during the zooming of the content.

17. A system for zooming presentation content, comprising:
a display;
a network connection that is coupled to tenants of the multi-tenant service;
a processor and a computer-readable medium;
an operating environment stored on the computer-readable medium and executing on the processor; and
a process operating under the control of the operating environment and operative to perform actions, comprising:
displaying a slide in the presentation on the display;
identifying content on the slide to zoom during the presentation;
zooming the identified content and displaying an animation while zooming the content; and
displaying the zoomed content.

18. The system of claim 17, wherein identifying the content to zoom during the presentation comprises selecting the content to zoom and setting a zoom level on a presenter display without displaying the selection of the content and the setting of the zoom level on an audience display; displaying the zoomed content on the presenter display and when a preview and adjustment of the zoomed content is completed, displaying the zoomed content on the audience display.

19. The computer-readable medium of claim 17, further comprising allowing interaction with selectable items within the content while the zoomed content is displayed and allowing annotation to the zoomed content.

20. The computer-readable medium of claim 17, further comprising displaying zoomable content within the presentation differently from non-zoomable content.
